(19) United States
(12) Patent Application Publication
(10) Pub. No.: US 2025/0141919 A1
(43) Pub. Date: May 1, 2025

(54) COMMUNICATION DEVICE, NON-TRANSITORY COMPUTER-READABLE RECORDING MEDIUM STORING COMPUTER-READABLE INSTRUCTIONS FOR COMMUNICATION DEVICE, AND METHOD EXECUTED BY COMMUNICATION DEVICE

(71) Applicant: BROTHER KOGYO KABUSHIKI KAISHA, Nagoya (JP)

(72) Inventor: Satoru YANAGI, Obu (JP)

(21) Appl. No.: 18/924,009

(22) Filed: Oct. 23, 2024

(30) Foreign Application Priority Data
Oct. 30, 2023 (JP) 2023-185830

(51) Int. Cl. H04L 9/40

(52) U.S. Cl. CPC H04L 63/1458; H04L 63/1416; H04L 2463/142

(57) ABSTRACT

A communication device may receive, from a first external device, attack detection information indicating that a specific attack has been detected; in a case where the attack detection information is received from the first external device and a first program for addressing the specific attack exists, update a second program stored in the communication device by using the first program; and in a case where the attack detection information is received from the first external device and the first program does not exist, execute a first addressing process for addressing the specific attack, the first addressing process being indicated by specific addressing information received from a first server.

### REFERENCE TO RELATED APPLICATION

This application claims priority to Japanese Patent Application No. 2023-185830 filed on Oct. 30, 2023. The entire content of the priority application is incorporated herein by reference.

### BACKGROUND ART

A virtual network including a plurality of information processing devices and a communication line is known. Each information processing device changes a port number to be used when another information processing device is experiencing a DOS attack.

### SUMMARY

The disclosure herein provides a novel technology for addressing a specific attack.

The disclosure herein provides a communication device. The communication device may comprise a controller. The controller may be configured to: receive, from a first external device, attack detection information indicating that a specific attack has been detected; in a case where the attack detection information is received from the first external device and a first program for addressing the specific attack exists, update a second program stored in the communication device by using the first program; and in a case where the attack detection information is received from the first external device and the first program does not exist, execute a first addressing process for addressing the specific attack, the first addressing process being indicated by specific addressing information received from a first server.

According to the configuration above, the communication device updates the second program by using the first program in the case where the communication device receives the attack detection information from the first external device and the first program exists. The communication device executes the first addressing process in the case where the communication device receives the attack detection information from the first external device and the first program does not exist. Thus, the communication device can appropriately address the specific attack regardless of whether the first program exists or not.

Computer-readable instructions for the above communication device, a non-transitory computer-readable recording medium storing the computer-readable instructions, and a method executed by the communication device are also novel and useful. Further, a communication system comprising the above communication device, first external device, and first server is also novel and useful.

### BRIEF DESCRIPTION OF DRAWINGS

FIG. 1 shows a configuration of a communication system.

FIG. 2 shows examples of tables.

FIG. 3 shows a flowchart of a printer process executed by a printer.

FIG. 4 shows a flowchart of a workaround process executed by the printer.

FIG. 5 shows a sequence diagram for Case A in which update firmware has been already registered in a firmware management server when an attack is detected.

FIG. 6 shows a sequence diagram for Case B in which the update firmware has not been registered in the firmware management server when an attack is detected.

### DESCRIPTION

### Embodiment

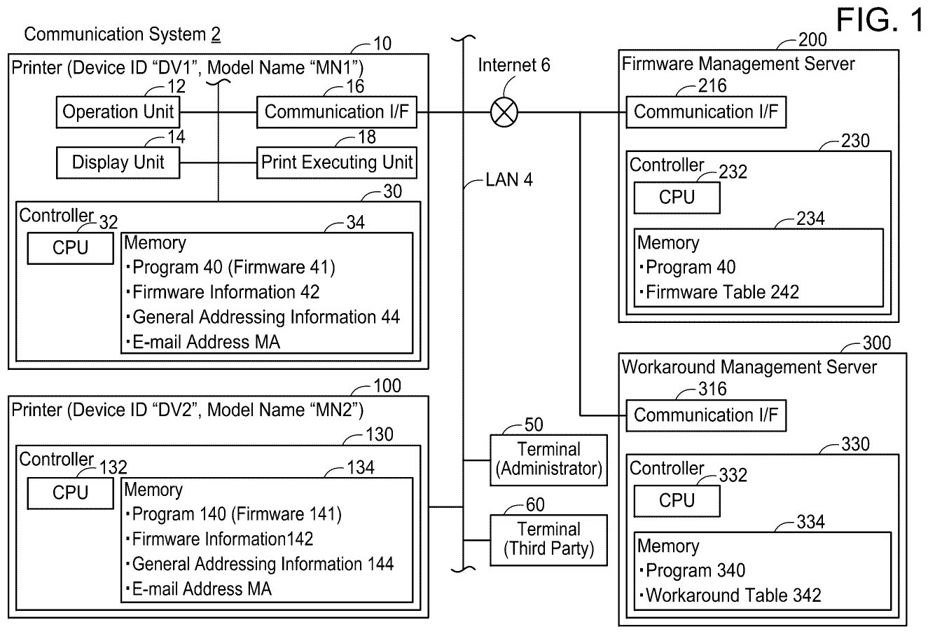

### Configuration of Communication System 2: FIG. 1

As shown in FIG. 1, a communication system 2 comprises a plurality of printers 10, 100, a terminal 50, a firmware management server 200, and a workaround management server 300. The printers 10, 100 and the terminal 50 are connected to a local area network (LAN) 4 and communicable with each other via the LAN 4. The LAN 4 may be a wired LAN or a wireless LAN. The LAN 4 is connected to the internet 6. The devices 10, 50, 100, 200, and 300 are communicable with each other via the internet 6. This embodiment premises that a terminal 60 of a third party belongs to the LAN 4.

### Configurations of Printers 10, 100

The printers 10, 100 are peripheral devices (e.g., peripheral devices of the terminal 50) configured to execute a print function. The printer 10 has a device ID “DV1” and a model name “MN1”. Device IDs are given by the administrators of printers. Model names indicate the models of printers. The printer 10 comprises an operation unit 12, a display unit 14, a communication interface 16, a print executing unit 18, and a controller 30. Hereinafter, an interface may be abbreviated as “I/F”.

The operation unit 12 is an interface for inputting various information to the printer 10 and comprises buttons, a touch screen, etc. The display unit 14 is a display or a panel configured to display various information. The communication I/F 16 is an interface for communication with other devices. The communication I/F 16 is connected to the LAN 4. The communication I/F 16 may be a wired I/F or a wireless I/F. The print executing unit 18 comprises a print engine of electrophotographic scheme, inkjet scheme, or thermal scheme.

The controller 30 comprises a CPU 32 and a memory 34. The memory 34 comprises a main storage and an auxiliary storage of the memory 34. The CPU 32 is configured to execute various processes according to a program 40 stored in the auxiliary storage. Specifically, the CPU 32 loads the program 40 from the auxiliary storage to the main storage and executes the program 40 to execute the various processes. The main storage is for example a RAM and a cache memory. The auxiliary storage is for example a flash memory, a solid state drive (SSD), or a ROM or a combination of them. The program 40 includes firmware 41 for implementing specific operations of the printer 10 (e.g., operation of the print executing unit 18, etc.). The memory 34 further stores firmware information 42, general addressing information 44, and an e-mail address MA. The firmware information 42 includes version information of the firmware 41 installed in the printer 10 and a vulnerability ID (VID) corresponding to an attack the firmware 41 can address. The general addressing information 44 is general information for addressing various attacks against printers. In this embodiment, the general addressing information 44 indicates a process for disabling a port not supporting user authentication. The e-mail address MA is an e-mail address of the administrator of the printers 10, 100.

The printer 100 has a device ID “DV2” and a model name “MN2”. The printer 100 comprises an operation unit (not shown), a display unit (not shown), a communication I/F (not shown), a print executing unit (not shown), and a controller 130. The controller 130 comprises a CPU 132 and a memory 134. The memory 134 comprises a main storage and an auxiliary storage. The CPU 132 is configured to execute various processes according to a program 140 stored in the auxiliary storage of the memory 134. Specifically, the CPU 132 loads the program 140 from the auxiliary storage to the main storage and execute the program 140 to execute the various processes. The program 140 includes firmware 141 for implementing specific operations of the printer 100. The memory 134 further stores firmware information 142, general addressing information 144, and the e-mail address MA. The firmware information 142 includes version information of the firmware 141 installed in the printer 100 and a VID corresponding to an attack the firmware 141 can address. The general addressing information 144 is general information for addressing various attacks against printers. In this embodiment, the general addressing information 144 is the same as the general addressing information 44 stored in the printer 10. In a modification, the general addressing information 144 may be different from the general addressing information 44 stored in the printer 10.

### Configuration of Firmware Management Server 200

The firmware management server 200 is established on the internet 6 by the vendor of the printers 10, 100 (simply termed “the vendor” hereinafter). In a modification, the firmware management server 200 may be established on the internet 6 by a business operator different from the vendor. In another modification, the vendor may not prepare hardware for the firmware management server 200 by themselves and may use an environment provided by an external cloud computing service. In this case, the vendor may prepare a program (i.e., software) for the firmware management server 200 and introduce it to the above-mentioned environment to implement the firmware management server 200.

The firmware management server 200 manages, for respective printers of multiple types provided by the vendor, firmware for the printers. The firmware management server 200 comprises a communication I/F 216 and a controller 230. The communication I/F 216 is connected to the internet 6. The controller 230 comprises a CPU 232 and a memory 234. The memory 234 comprises a main storage and an auxiliary storage. The CPU 232 is configured to execute various processes according to a program 240 stored in the auxiliary storage of the memory 234. Specifically, the CPU 232 loads the program 240 from the auxiliary storage to the main storage and executes the program 240 to execute the various processes. The memory 234 further stores a firmware table 242.

### Configuration of Workaround Management Server 300

The workaround management server 300 is established on the internet 6 by the vendor. In a modification, the workaround management server 300 may be established on the internet 6 by a business operator different from the vendor. In another modification, the vendor may not prepare hardware for the workaround management server 300 by themselves and may use an environment provided by an external cloud computing service. In this case, the vendor may prepare a program (i.e., software) for the workaround management server 300 and introduce it to the above-mentioned environment to implement the workaround management server 300.

The workaround management server 300 manages, for respective printers of multiple types provided by the vendor, workarounds for the printers. Workarounds are information indicating methods of addressing vulnerabilities. The workaround management server 300 comprises a communication I/F 316 and a controller 330. The communication I/F 316 is connected to the internet 6. The controller 330 comprises a CPU 332 and a memory 334. The memory 334 comprises a main storage and an auxiliary storage. The CPU 332 is configured to execute various processes according to a program 340 stored in the auxiliary storage of the memory 334. Specifically, the CPU 332 loads the program 340 from the auxiliary storage to the main storage and executes the program 340 to execute the various processes. The memory 334 further stores a workaround table 342.

### Configurations of Terminals 50, 60

The terminal 50 is an administrator terminal used by the administrator of the printers 10, 100. The terminal 60 is a terminal used by a third party that can attack the printers 10, 100. The terminals 50, 60 are each a portable terminal device such as a mobile phone, a smartphone, a PDA, a laptop PC, a tablet PC or the like. In a modification, the terminal 50 may be a stationary terminal device such as a desktop PC or the like.

Types of possible attacks against the printers 10, 100 from external devices (e.g., the terminal 60), i.e., types of vulnerabilities of the printers 10, 100 include for example SQL injection, cross site scripting, CSRF (cross-site request forgery), directory traversal, OS command injection, session management defects, HTTP header injection, unauthorized e-mail relay, etc.

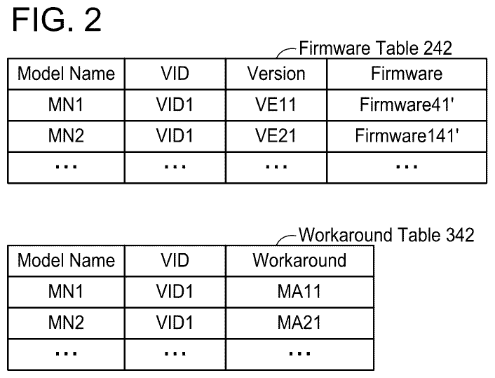

### Details of Tables: FIG. 2

Referring to FIG. 2, the firmware table 242 in the firmware management server 200 and the workaround table 342 in the workaround management server 300 are described.

In the firmware table 242, model names, VIDs, version information, and firmware are stored in association with each other. Each version information indicates a version of the associated firmware. The information in the firmware table 242 is registered by the administrator of the firmware management server 200.

In the workaround table 342, model names, VIDs, and workarounds are stored in association with each other. Each workaround in the workaround table 342 indicates a method of addressing a vulnerability identified by the associated VID. The information in the workaround table 342 is registered by the administrator of the workaround management server 300.

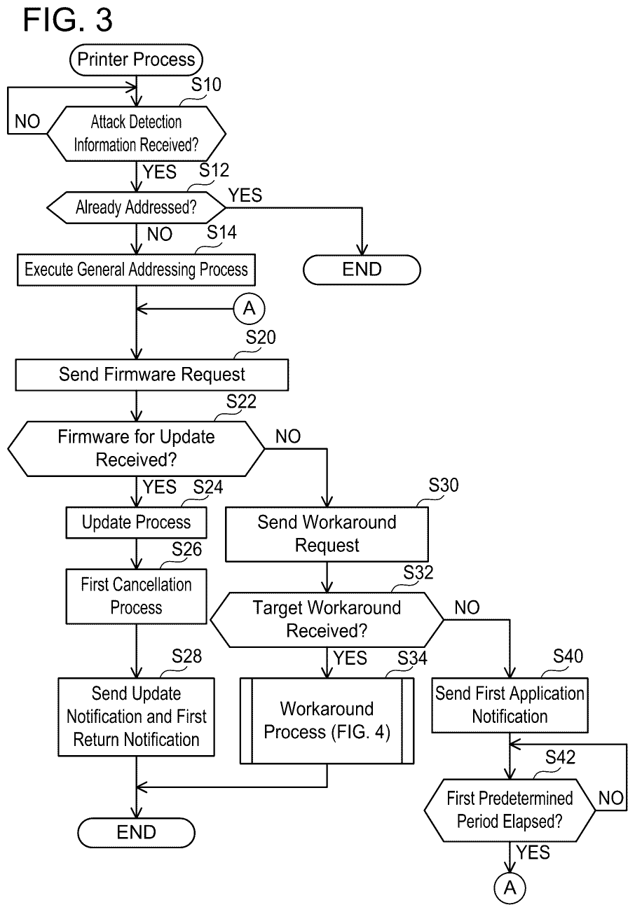

### Printer Process: FIG. 3

Referring to FIG. 3, a printer process executed by the CPU 32 of the printer 10 is described. The CPU 32 starts the process of FIG. 3 in response to the printer 10 being turned on. In the following description, all communications between the devices are executed via the communication I/Fs 16, 216, 316. Therefore, phrases “via the communication I/F 16”, “via the communication I/F 216”, and “via the communication I/F 316” are omitted in descriptions on communications between the devices.

In S10, the CPU 32 monitors whether attack detection information is received from another printer. The attack detection information indicates that the other printer has detected an attack from an external device. The attack detection information includes a VID. When receiving the attack detection information from another printer, the CPU 32 determines YES in S10 and proceeds to S12.

In S12, the CPU 32 specifies the VID included in the received attack detection information (which is termed “target VID”) and determines whether a vulnerability corresponding to the target VID has already been addressed. Specifically, the CPU 32 determines whether the firmware information 42 in the memory 34 includes the target VID. When the firmware information 42 includes the target VID, the CPU 32 determines YES in S12 and terminates the process of FIG. 3. Conversely, when the firmware information 42 does not include the target VID, the CPU 32 determines NO in S12 and proceeds to S14.

In S14, the CPU 32 executes a general addressing process using the general addressing information 44 in the memory 34. Specifically, the CPU 32 changes the state of a port not supporting user authentication from an enabled state to a disabled state. As a result, the printer 10 shifts from a normal state to a first attack addressing state in which the printer 10 is able to address various attacks from the third party.

In S20, the CPU 32 sends a firmware request including the model name “MN1” and the target VID to the firmware management server 200. The firmware request is a signal for requesting the firmware management server 200 to send firmware associated with the model name “MN1” and the target VID in the firmware request (which is termed “update firmware”). The firmware request is also a signal for checking whether update firmware exists. In response to receiving the firmware request from the printer 10, the firmware management server 200 determines whether update firmware, which is associated with the model name “MN1” and the target VID included in the firmware request, is in the firmware table 242. When the update firmware is in the firmware table 242, the firmware management server 200 specifies the version information associated with the update firmware in the firmware table 242 and sends the specified version information and the update firmware to the printer 10. Conversely, when the update firmware is not in the firmware table 242, the firmware management server 200 sends an error notification to the printer 10.

In S22, the CPU 32 determines whether the update firmware is received from the firmware management server 200. When the update firmware is received from the firmware management server 200 (YES in S22), the CPU 32 proceeds to S24. Conversely, when the update firmware is not received from the firmware management server 200 (NO in S22), the CPU 32 proceeds to S30.

In S24, the CPU 32 executes an update process to update the firmware 41 in the memory 34 by using the update firmware received in S22. The firmware 41 in the memory 34 is thereby updated to firmware that is able to address the vulnerability corresponding to the target VID. Further, the CPU 32 stores the target VID and the version information in the firmware information 42 in the memory 34.

In S26, the CPU 32 executes a first cancellation process to cancel the general countermeasure applied in S14. Specifically, the CPU 32 changes the state of the port not supporting user authentication from the disabled state to the enabled state. As a result, the printer 10 shifts from the first attack addressing state to the normal state. When the printer 10 is in the first attack addressing state, functions of the printer 10 are probably restricted as compared to when the printer 10 is in the normal state. Shifting the state of the printer 10 from the first attack addressing state to the normal state allows for cancellation of the function restrictions on the printer 10.

In S28, the CPU 32 sends an e-mail including an update notification, a first return notification, the target VID, and the device ID “DV1”, to the e-mail address MA in the memory 34. The update notification indicates that the firmware 41 of the printer 10 has been updated. The first return notification indicates that the state of the printer 10 has shifted from the first attack addressing state to the normal state. This allows the administrator of the printer 10 to know that the firmware 41 has been updated and the state of the printer 10 has shifted from the first attack addressing state to the normal state. When S28 is completed, the CPU 32 terminates the process of FIG. 3.

In S30, the CPU 32 sends a workaround request including the model name “MN1” and the target VID to the workaround management server 300. In response to receiving the workaround request from the printer 10, the workaround management server 300 determines whether a workaround associated with the model name “MN1” and the target VID included in the workaround request (which is termed “target workaround”) is in the workaround table 342. When the target workaround is in the workaround table 342, the workaround management server 300 sends the target workaround to the printer 10. Conversely, when the target workaround is not in the workaround table 342, the workaround management server 300 sends an error notification to the printer 10.

In S32, the CPU 32 determines whether the target workaround is received from the workaround management server 300. When the target workaround is received from the workaround management server 300 (YES in S32), the CPU 32 proceeds to S34. Conversely, when the target workaround is not received from the workaround management server 300 (NO in S32), the CPU 32 proceeds to S40.

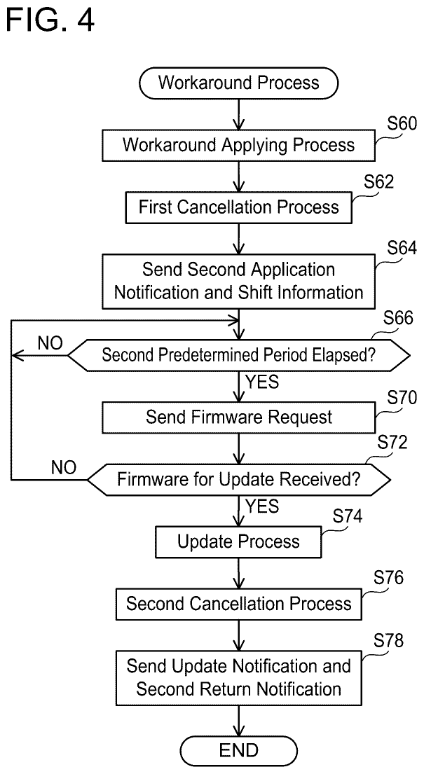

In S34, the CPU 32 executes a workaround process (see FIG. 4). The workaround process is a process to apply the target workaround to the printer 10.

In S40, the CPU 32 sends an e-mail including a first application notification, the target VID, the device ID “DV1”, and the general addressing information 44, to the e-mail address MA in the memory 34. The first application notification indicates that the state of the printer 10 has shifted from the normal state to the first attack addressing state.

In S42, the CPU 32 monitors whether a first predetermined period (e.g., 12 hours) has elapsed after the first application notification was sent. When the first predetermined time period has elapsed, the CPU 32 determines YES in S42 and returns to S20.

### Workaround Process: FIG. 4

Referring to FIG. 4, the workaround process executed in S34 of FIG. 3 is described.

In S60, the CPU 32 executes a workaround applying process to apply the target workaround to the printer 10. In an example, the target workaround is to block access to protected resources, i.e., an area of the memory.

In another example, the target workaround is to send header information included in a packet from an external terminal to the workaround management server 300. This workaround is a tentative countermeasure for addressing an HTTP header injection vulnerability.

In another example, the target workaround is to block access to a database. This workaround is a tentative countermeasure for addressing for example an SQL injection vulnerability.

In another example, the target workaround is to block script execution. This workaround is a n addressing for example a cross-site scripting vulnerability.

In another example, the target workaround is to block OS commands. This workaround is a tentative countermeasure for addressing for example an OS command injection vulnerability.

In another example, the target workaround is to use another session ID creating method. This workaround is a tentative countermeasure for addressing for example a vulnerability of session management defects.

In another example, the target workaround is to block e-mail relay. This workaround is a tentative countermeasure for addressing a vulnerability of unauthorized e-mail relay.

In another example, the target workaround is to block connection to destination port numbers included in an IP address of the terminal 60 and a packet of the attack.

In S62, the CPU 32 executes the first cancellation process to cancel the general countermeasure applied in S14. As a result, the state of the printer 10 shifts from the first attack addressing state to a second attack addressing state in which the printer 10 is able to address the vulnerability corresponding to the target VID since the target workaround has been applied. When the printer 10 is in the first attack addressing state, the functions of the printer 10 are probably restricted more strictly as compared to when the printer 10 is in the second attack addressing state. Shifting the state of the printer 10 from the first attack addressing state to the second attack addressing state allows for cancellation of the stricter function restrictions on the printer 10.

In S64, the CPU 32 sends an e-mail including a second application notification, a shift notification, the target VID, and the device ID “DV1”, to the e-mail address MA in the memory 34. The second application notification indicates that the workaround has been applied. The shift notification indicates that the state of the printer 10 has shifted from the first attack addressing state to the second attack addressing state. This allows the administrator of the printer 10 to know that the workaround process has been executed and that the state of the printer 10 has shifted from the first attack addressing state to the second attack addressing state.

In S66, the CPU 32 monitors whether a second predetermined period (e.g., 12 hours) has elapsed after the second application notification and the shift notification were sent. When the second predetermined period has elapsed, the CPU 32 determines YES in S66 and proceeds to S70. The second predetermined period may be the same as or different from the first predetermined period in FIGS. 3.

S70 and S72 are the same as S20 and S22 in FIG. 3, respectively. When determining YES in S72, the CPU 32 proceeds to S74, whereas when determining NO in S72, the CPU 32 returns to S66. In S66 following the determination of NO in S72, the CPU 32 monitors whether the second predetermined period has elapsed after the firmware request was sent. S74 is the same as S24 in FIG. 3.

In S76, the CPU 32 executes a second cancellation process to cancel the target workaround. Thereby, the state of the printer 10 shifts from the second attack addressing state to the normal state. As above, when the situation changes from the situation where the update firmware does not exist to the situation where the update firmware exists after the workaround applying process has been executed, the CPU 32 executes the update process and the second cancellation process. When the printer 10 is in the second attack addressing state, the functions of the printer 10 are probably restricted as compared to when the printer 10 is in the normal state. Shifting the state of the printer 10 from the second attack addressing state to the normal state allows for cancellation of the function restrictions on the printer 10. The reason that the firmware is updated after the workaround applying process has been executed is because the workaround is information (a program) for taking a tentative countermeasure to address an external attack before firmware is provided.

In S78, the CPU 32 sends an e-mail including the update notification, a second return notification, the target VID, and the device ID “DV1”, to the e-mail address MA in the memory 34. The second return notification indicates that the state of the printer 10 has shifted from the second attack addressing state to the normal state. This allows the administrator of the printer 10 to know that the state of the printer 10 has shifted from the second attack addressing state to the normal state. When S78 is completed, the CPU 32 terminates the process of FIG. 4.

In this embodiment, the CPU 132 of the printer 100 is also configured to execute the printer process of FIG. 3 and the workaround process of FIG. 4. In the printer process and workaround process executed by the CPU 132, the firmware requests (see S20 in FIG. 3, S70 in FIG. 4) and the workaround request (see S30 in FIG. 3) include the model name “MN2”.

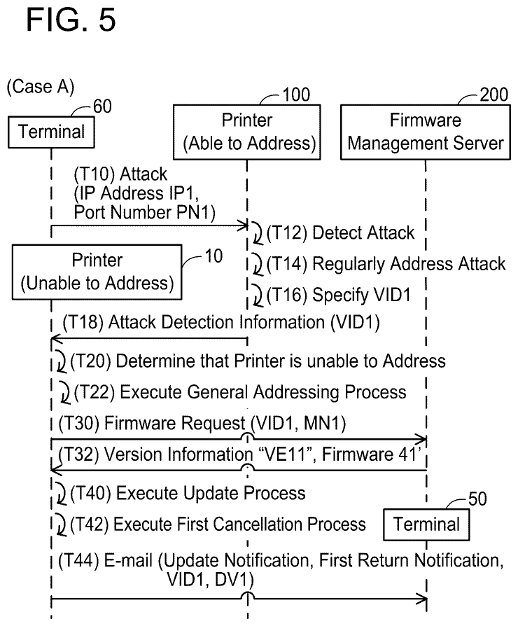

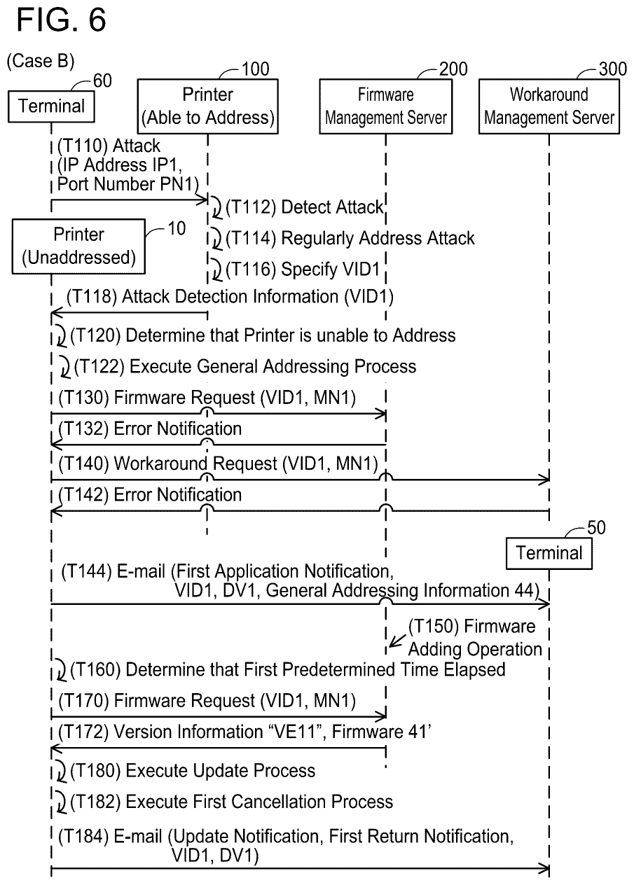

### Specific Cases: FIGS. 5, 6

Referring to FIGS. 5 and 6, specific cases that can be realized by the communication system 2 according to this embodiment are described. Hereinafter, actions are described with the devices (e.g., the printer 10, etc.) as the subjects of actions, instead of described with the CPUs (e.g., the CPU 32) of the devices as the subjects of actions.

### Case A: FIG. 5

Referring to FIG. 5, Case A in which the printer 100 is attacked by the terminal 60 is described. In the initial state of Case A, the printer 100 is able to address an attack from the terminal 60, whereas the printer 10 is not able to address an attack from the terminal 60. Also, in the firmware table 242 in the firmware management server 200, the model name “MN1”, a VID “VID1”, version information “VE11”, and firmware 41′ are stored in association with each other.

In T10, the terminal 60 attacks the printer 100. A packet of the attack includes an IP address “IP1” of the terminal 60 and a destination port number “PN1”.

In response to being attacked by the terminal 60 in T10, the printer 100 detects the attack in T12. When the packet is detected as an attack from an external, the printer 100 does not execute a process according to commands included in the packet. In T14, the printer 100 specifies the type of attack and addresses the attack regularly. In an example, when the type of attack corresponds to a directory traversal vulnerability of the printer 100, the printer 100 regularly addresses the attack by prohibiting a path with a predetermined directory structure from being specified. Then, the printer 100 specifies, in T16, the VID “VID1” which identifies the vulnerability corresponding to the attack detected in T12, and broadcasts attack detection information including the specified VID “VID1” via the LAN 4 in T18. Thereby, the attack detection information is sent to devices within the LAN 4.

In response to receiving the attack detection information from the printer 100 in T18 (YES in S10 of FIG. 3), the printer 10 specifies the VID “VID1” included in the information. The printer 10 determines in T20 that the printer 10 is unable to address the vulnerability corresponding to the VID “VID1” because the firmware information 42 in the memory 34 does not include the VID “VID1” (NO in S12), and executes the general addressing process using the general addressing information 44 in the memory 34 in T22 (S14). Then, the printer 10 sends a firmware request including the model name “MN1” and the VID “VID1” to the firmware management server 200 in T30.

In response to receiving the firmware request from the printer 10 in T30, the firmware management server 200 specifies the model name “MN1” and the VID “VID1” included in the firmware request and determines that the firmware 41′ associated with the specified model name “MN1” and the VID “VID1” (i.e., update firmware) is in the firmware table 242. In this case, the firmware management server 200 specifies the version information “VE11” associated with the firmware 41′ in the firmware table 242 and sends the specified version information “VE11” and the firmware 41′ to the printer 10 in T32.

In response to receiving the version information “VE11” and the firmware 41′ from the firmware management server 200 in T32 (YES in S22), the printer 10 executes the update process to update the firmware 41 in the memory 34 by using the received firmware 41′ in T40 (S24). Then, the printer 10 executes the first cancellation process to shift the state of the printer 10 from the first attack addressing state to the normal state in T42 (S26) and sends an e-mail including the update notification, the first return notification, the VID “VID1”, and the device ID “DV1” to the e-mail address MA in the memory 34 in T44. As above, the firmware 41 in the printer 10 is updated to the firmware that is able to address the vulnerability corresponding to the VID “VID1”. Thus, when the printer 10 is attacked by the terminal 60 after the update, the printer 10 is able to address the attack.

### Advantageous Effects of Case A

As described, the printer 10 receives the attack detection information from the printer 100 which belongs to the LAN 4 (T18 in FIG. 5). The printer 10 which belongs to the same LAN highly likely undergoes the same attack as the one against the printer 100. By receiving the attack detection information from the printer 100, the printer 10 can prepare itself so as to address the attack.

The printer 10 executes the general addressing process (T22) after receiving the attack detection information from the printer 100. Thus, even when the printer 10 is attacked by the terminal 60 before executing the update process or before executing the workaround applying process, the printer 10 can address the attack.

### Case B: FIG. 6

Referring to FIG. 6, Case B in which the printer 100 is attacked by the terminal 60 is described. The initial state of Case B is the same as the initial state of Case A of FIG. 5 except that the firmware 41′ is not in the firmware table 242 in the firmware management server 200.

T110 to T122 are the same as T10 to T22 in FIG. 5.

In response to receiving a firmware request from the printer 10 in T130, the firmware management server 200 specifies the model name “MN1” and the VID “VID1” included in the firmware request and determines that firmware associated with the specified model name “MN1” and VID “VID1” is not in the firmware table 242. In this case, the firmware management server 200 sends an error notification to the printer 10 in T132.

In response to receiving the error notification from the firmware management server 200 in T132, the printer 10 determines that update firmware is not received from the firmware management server 200 (NO in S22). In this case, the printer 10 sends a workaround request including the model name “MN1” and the VID “VID1” to the workaround management server 300 in T140 (S30).

In response to receiving the workaround request from the printer 10 in T140, the workaround management server 300 specifies the model name “MN1” and the VID “VID1” included in the workaround request and determines that a workaround associated with the specified model name “MN1” and VID “VID1” is not in the workaround table 342. In this case, the workaround management server 300 sends an error notification to the printer 10 in T142.

In response to receiving the error notification from the workaround management server 300 in T142, the printer 10 determines that the target workaround is not received from the workaround management server 300 (NO in S32). In this case, the printer 10 sends an e-mail including the first application notification, the VID “VID1”, the device ID “DV1”, and the general addressing information 44 to the e-mail address MA in the memory 34. This allows the administrator to know, when he/she uses the terminal 50, that the general addressing information 44 has been applied to the printer 10.

Thereafter, the administrator of the firmware management server 200 adds the firmware 41′ to the firmware table 242 in T150. Thereby, the model name “MN1”, the VID “VID1”, the version information “VE11”, and the firmware 41′ are stored in association with each other in the firmware table 242.

The printer 10 determines in T160 that the first predetermined period has elapsed after the first application notification was sent (YES in S42) and sends a firmware request including the model name “MN1” and the VID “VID1” to the firmware management server 200 in T170. T172 and T180 to T184 are the same as T32 and T40 to T44 in FIG. 5, respectively. As above, the firmware 41 in the printer 10 is updated to the firmware that is able to address the vulnerability corresponding to the VID “VID1”.

### Advantageous Effects of Embodiment

As described, in the case where the printer 10 receives the attack detection information from the printer 100 and the update firmware exists (YES in S22 of FIG. 3), the printer 10 updates the firmware 41 in the memory 34 by using the update firmware (S24). Conversely, in the case where the printer 10 receives the attack detection information from the printer 100 and the update firmware does not exist (NO in S22), the printer 10 executes the workaround applying process (S60 in FIG. 4). Thus, the printer 10 can address the specific attack regardless of whether the update firmware exists or not.

### Correspondence Relationships

The printer 10 is an example of “communication device”. The printer 100 is an example of “first external device”. The attack in T10 of FIG. 5 is an example of “specific attack”. The firmware 41 is an example of “first program”. The firmware 41′ is an example of “second program”. The workaround management server 300 is an example of “first server”. A workaround in the workaround table 342 in the workaround management server 300 is an example of “specific addressing information”. The workaround applying process in S60 of FIG. 4 is an example of “first addressing process”. A VID is an example of “identification information”. A firmware request is an example of “program request”. The firmware management server 200 is an example of “second server”. The LAN 4 is an example of “same network”. The update notification in S28 of FIG. 3 is an example of “first notification”. The second application notification in S64 of FIG. 4 is an example of “second notification”. The second attack addressing state is an example of “first addressing state”. The second return notification in S78 of FIG. 4 is an example of “third notification”. The general addressing process in S14 of FIG. 3 is an example of “second addressing process”. The port unavailable for user authentication is an example of “specific port”. The first attack addressing state is an example of “second addressing state”. The first return notification in S28 of FIG. 3 is an example of “fourth notification”. The shift notification in S64 of FIG. 4 is an example of “fifth notification”.

S10 in FIG. 3 is an example of “receive, from a first external device, attack detection information”. S24 in FIG. 3 is an example of “update a second program”. S60 in FIG. 4 is an example of “execute a first addressing process”.

(Modification 1) In a case where the printer 100 is able to address an attack from the terminal 60, the printer 100 may send a VID corresponding to the attack to the workaround management server 300. Then, in a case where the VID is received from the printer 100 and a workaround associated with the VID is in the workaround table 342, the workaround management server 300 may send attack detection information including the VID and the workaround to the printer 10. Conversely, in a case where the VID is received from the printer 100 and a workaround associated with the VID is not in the workaround table 342, the workaround management server 300 may send attack detection information including the VID to the printer 10. In this modification, the workaround management server 300 is an example of “first external device”.

(Modification 2) The communication system 2 may comprise a honeypot connected to the LAN 4. The honeypot is a decoy device to be exposed to attacks from externals in place of other devices within the LAN 4. When attacked, the honeypot specifies a VID identifying a vulnerability corresponding to the attack and broadcasts attack detection information including the VID via the LAN 4. In this modification, the honeypot is an example of “first external device”.

(Modification 3) In S28 of FIG. 3, the CPU 32 of the printer 10 may not send the update notification. Further, in S64 of FIG. 4, the CPU 32 may not send the second application notification. In this modification, “send a first notification” and “send a second notification” may be omitted.

(Modification 4) S66 to S76 in FIG. 4 may be omitted. In this embodiment, “update the second program by using the first program” and “shift the state of the communication device from the first addressing state to the normal state” may be omitted.

(Modification 5) In S78 of FIG. 4, the CPU 32 of the printer 10 may not send the second return notification. In this modification, “send a third notification” may be omitted.

(Modification 6) S14 and S26 in FIGS. 3 and S76 in FIG. 4 may be omitted. In this modification, the general addressing information 44 may not be stored in the memory 34 of the printer 10. Further, in this modification, the CPU 32 of the printer 10 may not send the first return notification (see S28 in FIG. 3), the shift notification (see S64 in FIG. 4), nor the second return notification (see S78 in FIG. 4). In this modification, “execute the second addressing process”, “shift the state of the communication device from the second addressing state to the normal state”, “shift the state of the communication device from the second addressing state to a first addressing state”, and “send a fourth notification” and “send a fifth notification” may be omitted.

(Modification 7) The general addressing information 44 may indicate a process to block inbound communication, a process to block inbound communication with devices that have not accessed the printer 10 in the past, or the like. In another modification, a list of devices that have accessed the printer 10 in the past may be stored in the memory 34 of the printer 10. In this case, the general addressing information 44 may indicate a process to block inbound communication with devices that are not on the list. In another modification, the general addressing information 44 may indicate a process to discard or encrypt document data stored in the printer 10.

(Modification 8) S26 in FIGS. 3 and S62 and S76 in FIG. 4 may be omitted. For example, when receiving from the administrator an operation to cancel the general countermeasure indicated by the general addressing information 44, the printer 10 may execute a process to cancel the general countermeasure. In this modification, “shift the state of the communication device from the second addressing state to the normal state”, “shift the state of the communication device from the second addressing state to a first addressing state”, and “send a fourth notification” and “send a fifth notification” may be omitted.

(Modification 9) In S28 of FIG. 3, the CPU 32 of the printer 10 may not send the first return notification. In this modification, “send a fourth notification” may be omitted.

(Modification 10) In S64 of FIG. 4, the CPU 32 of the printer 10 may not send the shift notification. In this modification, “send a fifth notification” may be omitted.

(Modification 11) The firmware management server 200 and the workaround management server 300 may be configured as a single server.

(Modification 12) In the embodiments above, the processes of FIGS. 3 to 6 are implemented by software (e.g., the programs 40, 140, 240, 340), however, at least one of these processes may be implemented by hardware such as a logic circuit.

What is claimed is:

1. A communication device comprising:
a controller configured to:
receive, from a first external device, attack detection information indicating that a specific attack has been detected;
in a case where the attack detection information is received from the first external device and a first program for addressing the specific attack exists, update a second program stored in the communication device by using the first program; and
in a case where the attack detection information is received from the first external device and the first program does not exist, execute a first addressing process for addressing the specific attack, the first addressing process being indicated by specific addressing information received from a first server.

2. The communication device according to claim 1, wherein
the attack detection information includes identification information for identifying the specific attack,
the controller is further configured to:
in a case where the attack detection information is received from the first external device, send a program request including the identification information to a second server;
determine that the first program exists in a case where the first program is received from the second server in response to the program request having been sent to the second server; and
determine that the first program does not exist in a case where the first program is not received from the second server in response to the program request having been sent to the second server.

3. The communication device according to claim 1, wherein
the first external device belongs to a same network to which the communication device belongs, and
the attack detection information indicates that the first external device has detected the specific attack.

4. The communication device according to claim 1, wherein
the controller is further configured to:
in a case where the second program is updated, send a first notification indicating that the second program has been updated to an external; and
in a case where the first addressing process is executed, send a second notification indicating that the first addressing process has been executed to an external.

5. The communication device according to claim 1, wherein
in response to the first addressing process being executed, a state of the communication device is shifted from a normal state in which the communication device does not address the specific attack to a first addressing state in which the communication device is able to address the specific attack,
the controller is further configured to:
in a case where a situation is changed from a situation where the first program does not exist to a situation where the first program exists after the first addressing process has been executed, update the second program by using the first program; and
in the case where the situation is changed from the situation where the first program does not exist to the situation where the first program exists after the first addressing process has been executed, shift the state of the communication device from the first addressing state to the normal state.

6. The communication device according to claim 5, wherein
the controller is further configured to:
in a case where the state of the communication device is shifted from the first addressing state to the normal state, send a third notification indicating that the state of the communication device has been shifted from the first addressing state to the normal state to an external.

7. The communication device according to claim 1, further comprising a memory configured to store general addressing information indicating a second addressing process, the second addressing process being a general addressing process for addressing an attack,
wherein the controller is further configured to:
in a case where the attack detection information is received from the first external device, execute the second addressing process indicated by the general addressing information in the memory.

8. The communication device according to claim 7, wherein
the second addressing process is a process for changing a specific port of the communication device from an enabled state to a disabled state.

9. The communication device according to claim 7, wherein
in response to the second addressing process being executed, a state of the communication device is shifted from a normal state in which the communication device does not address the specific attack to a second addressing state in which the communication device is able to address the specific attack,
the controller is further configured to:
in a case where the second program is updated after the second addressing process has been executed, shift the state of the communication device from the second addressing state to the normal state; and
in a case where the first addressing process is executed after the second addressing process has been executed, shift the state of the communication device from the second addressing state to a first addressing state in which the communication device is able to address the specific attack.

10. The communication device according to claim 9, wherein
the controller is further configured to:
in a case where the state of the communication device is shifted from the second addressing state to the normal state, send a fourth notification indicating that the state of the communication device has been shifted from the second addressing state to the normal state to an external.

11. The communication device according to claim 9, wherein
the controller is further configured to:
in a case where the state of the communication device is shifted from the second addressing state to the first addressing state, send a fifth notification indicating that the state of the communication device has been shifted from the second addressing state to the first addressing state to an external.

12. A non-transitory computer-readable recording medium storing computer-readable instructions for a communication device:
wherein the computer-readable instructions, when executed by the communication device, cause the communication device to:
receive, from a first external device, attack detection information indicating that a specific attack has been detected;
in a case where the attack detection information is received from the first external device and a first program for addressing the specific attack exists, update a second program stored in the communication device by using the first program; and
in a case where the attack detection information is received from the first external device and the first program does not exist, execute a first addressing process for addressing the specific attack, the first addressing process being indicated by specific addressing information received from a first server.

13. A method executed by a communication device, the method comprising:
receiving, from a first external device, attack detection information indicating that a specific attack has been detected;
in a case where the attack detection information is received from the first external device and a first program for addressing the specific attack exists, updating a second program stored in the communication device by using the first program; and
in a case where the attack detection information is received from the first external device and the first program does not exist, executing a first addressing process for addressing the specific attack, the first addressing process being indicated by specific addressing information received from a first server.
